(19) United States
(12) Patent Application Publication
(10) Pub. No.: US 2001/0042250 A1
(43) Pub. Date: Nov. 15, 2001

(54) Program selection device and program selection method

(76) Inventor: Hiroshi Ishii, Tokyo (JP)

Correspondence Address: Whitham, Curtis & Whitham, Reston International Center, Suite 900, 11800 Sunrise Valley Dr., Reston, VA, 20191, US

(21) Appl. No.: 09/756,911

(22) Filed: Jan. 10, 2001

(30) Foreign Application Priority Data
Jan. 11, 2000 (JP) 002367/2000

(51) Int. Cl. G06F 3/00; H04N 5/445

(52) U.S. Cl. 725/46

(57) ABSTRACT

A program selection device comprises a controller, an input section, an output section, an ES selector, an EPG storage section, and a program information storage section. The controller receives a program selected by a user through the input section and an EPG, and identifies a type code of the selected program by referring EPG. The controller increments a value of a counter by 1, for counting the number of times the user watches programs in association with program types. The ES selector selects an elementary stream of a type code, which corresponds to the largest counted value among any other counted values of a plurality of elementary streams included in the selected program. Thus the selected elementary stream are sent to a reproduction section together with the selected program, and thereby can be viewed by the user.

### BACKGROUND OF THE INVENTION

1. Field of the Invention

The present invention relates to a program selection device which can acquire information, such as any image data, text data, voice data, etc. according to user's interest or preference from a program, with using an electronic program guide transmitted together with the program.

2. Background Description

In recent years, digital broadcast systems, such as BS (Broadcasting Satellite) broadcast systems, CS (Communication Satellite) broadcast systems, etc., which transmit television signals in the form of digital signals, have come into wide use with the utilization of communications satellite channels. In addition, those digital broadcast systems transmitting digital signals via CATV (Cable Television) systems or the Internet have been widely accepted.

In the digital broadcast systems, a plurality of channels can be assigned to one frequency band using a digital data compression technique. As compared to the conventional analog broadcast systems, a large number of channels, approximately 150 channels, can be secured in the digital broadcast systems.

In such digital broadcast systems, to facilitate users selecting a program(s) from the large number of channels in accordance with their interest or preference, an EPG (Electronic Program Guide) including program information regarding programs to be broadcasted is sent to the users. Upon reception of the EPG, the users view information included in the EPG on a display. The information included in the EPG includes, channel numbers, program names, scheduled times, any additional information, etc. The users can select a desired program by referring to the above information.

Further, in the digital broadcast systems, with one program, various kinds of data, such as image data, voice data, and text data can be multiplexed in the form of elementary streams (ES) so as to provide such data, likewise various data broadcasting (for example, news, weather forecast, or CM (Commercial Message)). Accordingly, various kinds of data are multiplexed in one program to be broadcasted. Hence, the users can select any image data, voice data, text data, only based on their interest or preference.

For the users, it is preferred if they can select a variety of kinds of information which can be watched by them. However, it is not easy for the users to determine what image data, voice data, text data, to be provided to the users in accordance with their interest and preference.

Besides, it is quite time consuming to make such determination.

### SUMMARY OF THE INVENTION

The present invention has been made in consideration of the above problems. It is accordingly an object of the present invention to provide a program selection device and a program selection method which can select and provide image data, voice data, and text data based on the users' interest and preference.

In order to achieve the above object, according to the first aspect of the present invention, there is provided a program selection device which receives a plurality of programs and an EPG (Electronic Program Guide), and selects a particular elementary stream, of a plurality of elementary streams received together with one of the plurality of programs which is selected by a user, comprising:

a controller; and

a storage section, and

wherein said storage section stores a past record of the user viewing programs, in association with a plurality of predetermined types of the programs, and the received EPG, and

said controller identifies types of both the selected program and the multiplexed elementary streams in accordance with the EPG, calculates rates at which the user views programs in association with each of the types based on the past record, specifies a type of program based on the calculated rates, and selects an elementary stream corresponding to the specified type, of a plurality of elementary streams which are received together with the selected program.

According to the above structure, a type of program selected by a user is identified by referring to the EPG, and the rates at which the user watches (views) programs in association with types of the programs is calculated based on the past record of the user watching the programs. A type of program which is included in the EPG is selected on the basis of the calculated rates. One elementary stream (ES) corresponding to the selected program type and including image data, voice data and text data is selected among a plurality of elementary streams. Thus, information conforming to the interest and preference of the user can be provided.

In order to the achieve the above object, according to the second aspect of the present invention, there is provided a program selection device which receives a plurality of programs and an EPG, and selects a particular elementary stream, of a plurality of elementary streams received together with one of the plurality of programs which is selected by a user, said device comprising:

program receiving means for receiving the EPG, the selected program, and the plurality of elementary streams;

type identification means for identifying types of both the selected program and the plurality of elementary streams;

rate calculation means for calculating rates at which the user views programs in association with a plurality of program types;

rate storage means for storing the calculated rates in association with each of the program types; and

ES selection means for specifying a program type based on the calculated rates, and selecting an elementary stream of the plurality of elementary streams received by said program receiving means, the elementary stream corresponding to the specified program type.

According to this structure, a type of program corresponding to a program which is selected by the user and included in the EPG is identified. The rates at which the user watches the type of program which is thus selected is calculated. A type of program which is included in the EPG is selected on the basis of the calculated rates. One elementary stream is selected corresponding to the selected program type is selected among a plurality of elementary streams which are multiplexed with the selected program. Thus, those information conforming to the interest and preference of the user can be provided.

The rate storage means may include a counter for counting a number of times the user views programs in association with the program types.

The rate calculation means may increment, every time the user selects a program, a value of the counter corresponding each of the program types by 1, so as to obtain the rates based on the value of the counter.

According to this structure, the information conforming to the interest and preference of the user can be provided.

In order to the achieve the above object, according to the third aspect of the present invention, there is provided a program selection method for selecting a particular elementary stream of a plurality of elementary streams received together with one of the plurality of programs which is selected by a user, after receiving a plurality of programs and an EPG, said method comprising:

storing a past record of the user viewing programs in association with program types of the programs and the received EPG; and

identifying a program type of the selected program including the plurality of elementary streams based on the EPG, calculating rates at which the user views the programs in association with the program types based on the past record, and specifying a program type of a program based on the calculated rates, thereby to select one elementary stream of the plurality of elementary streams corresponding to the specified program type.

According to the above method, the program type of the program which the user selects based on the EPG is identified. The rates at which the user watches programs is calculated based on the past record. One program type is selected based on the calculated rates. One elementary stream corresponding to the program selected program type, of the plurality of elementary streams received together with the selected program, is selected. Hence, information conforming to the interest and preference of the users can be provided.

In order to achieve the above object, according to the fourth aspect of the present invention, there is provided a program selection method for selecting a particular elementary stream of a plurality of elementary streams received together with one of the plurality of programs which is selected by a user, after receiving a plurality of programs and an EPG, said method comprising:

receiving a program selected by the user, the plurality of elementary streams and the EPG;

identifying a program type of the selected program including the plurality of elementary streams;

calculating rates at which the user views the programs in association with a plurality of program types;

storing the rates which are calculated in association with the plurality of program types; and

specifying a program type based on the calculated rates, thereby to select one elementary stream, corresponding to the specified program type, of the plurality of elementary streams received in said receiving.

According to the above method, the program type of the program which is selected by the user based on the EPG. The rates at which the user watches programs is calculated. One program type, of the plurality of program types, is selected based on the calculated rates in association with each of the program types. One elementary stream of the plurality of elementary streams is selected in accordance with the selected program type. Hence, information conforming to the interest and preference of the user can be provided.

A counter for counting a number of times the user watches programs in association with the program types is used in said storing; and

in said calculating, every time the user selects a program, a value of the counter corresponding to each of the program types is incremented by 1, and the rates are obtained based on the value of the counter.

In this structure, the rates at which the user watches programs can easily be obtained in association with the program types.

Of the plurality of elementary streams which are multiplexed and included in the program selected by the user, an elementary stream corresponding to a most-frequently watched program type based on a calculation performed may be selected in said calculating.

In this structure, the user can view an elementary stream corresponding to a type code of the highest rate.

### BRIEF DESCRIPTION OF THE DRAWINGS

These objects and other objects and advantages of the present invention will become more apparent upon reading of the following detailed description and the accompanying drawings in which:

FIG. 1 is a block diagram exemplifying the structure of a receiver device including a program selection device according to an embodiment of the present invention;

FIG. 2 is a diagram showing an example of an EGP which is stored in an EPG storage section included in the program selection device;

FIG. 3 is a diagram showing an example of a type table including type codes and their corresponding types of program which are included in the EPG stored in the EPG storage section;

FIG. 4 is a diagram exemplifying data items included in each “ES Selection Information” of the EPG shown in FIG. 2;

FIG. 5 is a diagram showing a format of a program information table stored in a program information storage section included in the program selection device of the embodiment; and

FIG. 6 is a flowchart for explaining an ES selection process which is carried out by the program selection device.

### DETAILED DESCRIPTION OF THE PREFERRED EMBODIMENT

A program selection device and a program selection method according to an embodiment of the present invention will now be explained with reference to the accompanying drawings.

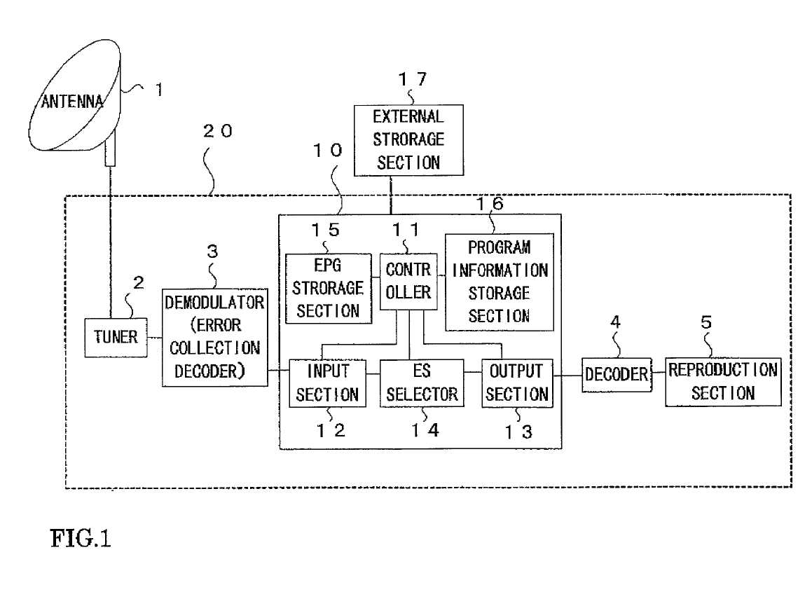

FIG. 1 is a block diagram showing an example of the structure of a receiver system including a program selection device according to the embodiment of the present invention. This receiver system is one for receiving digital data, and comprises an antenna 1 and a receiver device 20.

The receiver device 20 comprises a tuner 2, a demodulator 3, a program selection device 10, a decoder 4, a reproduction section 5, and an external storage section 17.

The antenna 1 receives EPGs and broadcast digital signals including multiplexed program identification information, etc. The tuner 2 selects a channel (i.e., a program) of an arbitrary broadcast station from the broadcast digital signals received by the antenna 1. The antenna 1 provides the demodulator 3 with the broadcast digital signals representing the program corresponding to the selected channel. The demodulator 3 demodulates the broadcast digital signals. The demodulator 3 includes an error correction encoder. The error correction encoder corrects any error in reading the broadcast digital signals. This error is caused by an interference signal occurring while transmitting the broadcast digital signals from the broadcast station to the antenna 1.

The program selection device 10 receives the broadcast digital signals which are demodulated by the demodulator 3, selects, and outputs the digital signals of the program corresponding to the selected channel.

The decoder 4 decodes the signals output from the program selection device 10, converts the signals into an MPEG (Motion Picture Expert Group)-2 transport stream, divides the decoded data into voice data, image data, text data, and sends the divided data to the reproduction section 5. The reproduction section 5 includes a display device, and reproduces the voice data, image data, and text data sent from the decoder 4.

The program selection device 10 comprises a controller 11, an input section 12, an output section 13, an ES (Elementary Stream) selector 14, and an EPG storage section 15, and a program information storage section 16. The program selection device 10 is connected to the external storage section 17.

Each program received by the input section 12 includes a plurality of elementary streams. Each of the plurality of elementary streams includes image signals, voice signals, and character signals regarding, for example, news, a weather forecast, a plurality of CMs for different products, and a plurality of CMs for the same product with different stories.

The input section 12 receives digital signals, representing an EPG and the program of the channel selected by the tuner 2 included in the receiver device 20, from the demodulator 3.

The output section 13 outputs signals of the program which includes an elementary stream selected by the ES selector 14 to the decoder 4.

The ES selector 14 receives the digital signals of the program including the plurality of elementary streams from the input section 12. The ES selector 14 receives also an ES selection control signal for instructing the ES selector 14 to select one elementary stream of the plurality of elementary streams. The ES selector 14 selects the one elementary stream of the plurality of elementary streams, based on the ES selection control signal, and sends digital signals representing the program including the selected elementary stream to the output section 13.

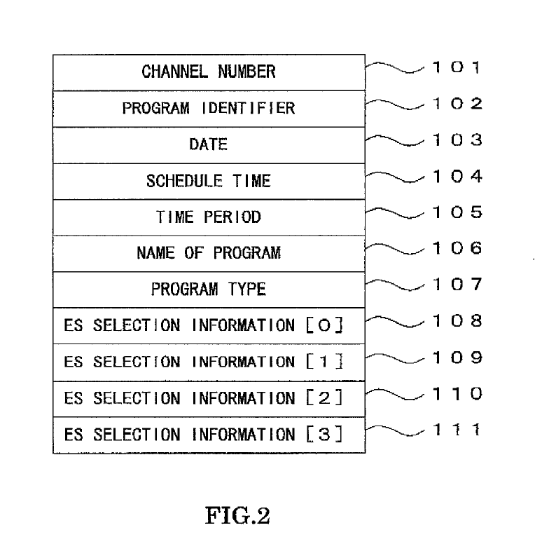

The EPG storage section 15 stores the EPG, represented by the digital signals received by the input section 12, under the control of the controller 11. FIG. 2 is a diagram showing an example of the EPG stored in the EPG storage section 15. As shown in FIG. 2, the EPG is composed of data areas of “Channel Number” 101, “Program Identifier” 102, “Date” 103, “Schedule Time” 104, “Time Period” 105, “Name of Program” 106, “Program Type” 107, “ES Selection Information [0]” 108, “ES Selection Information [1]” 109, “ES Selection Information [2]” 110, and “ES Selection Information [3]” 111.

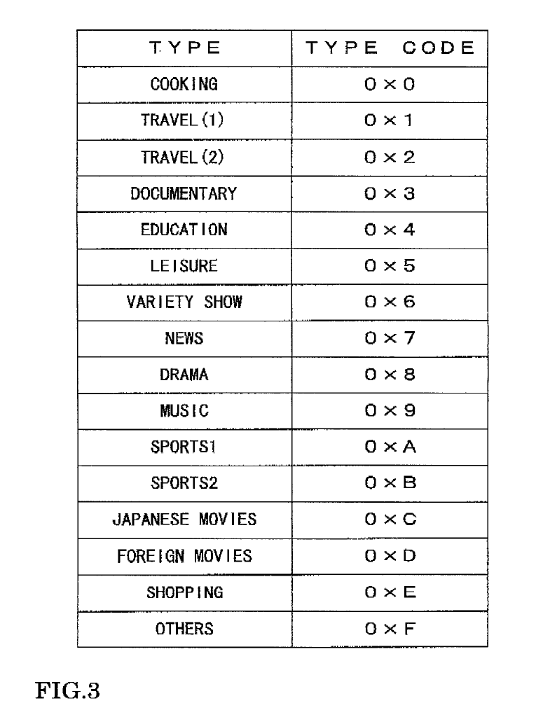

FIG. 3 is a diagram exemplifying a type table which stores classified program types, a corresponding one of which is described in the data area of “Type of Program” 107 in the EPG, and type codes corresponding to the respective types. Specifically, the type table includes sixteen categories of program type and type codes in association with each other, as shown in FIG. 3. As illustrated in FIG. 3, the types of program include, “Cooking”, “Travel 1”, “Travel 2”, “Documentary”, “Education”, and the like, as shown in FIG. 3. Each of the type codes corresponding to the respective sixteen categories of program types is made up of 8-bit text data.

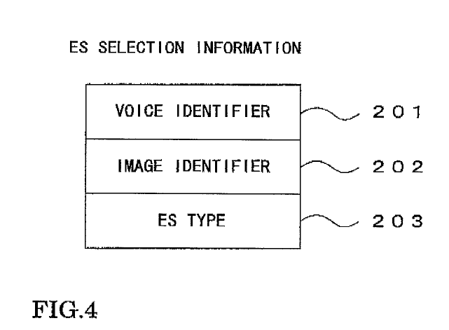

FIG. 4 is a diagram exemplifying data items included in each of the data areas of “ES selection information” 108, 109, 110 and 111. Each of the data areas of “ES selection information” 108, 109, 110 and 111 is composed of data items of “Voice Identifier” 201, “Image Identifier” 202, and “ES type” 203 representing the characteristics of the ES of the selected program. The data item of “ES type” 203 corresponds to one of the types of the type table shown in FIG. 3.

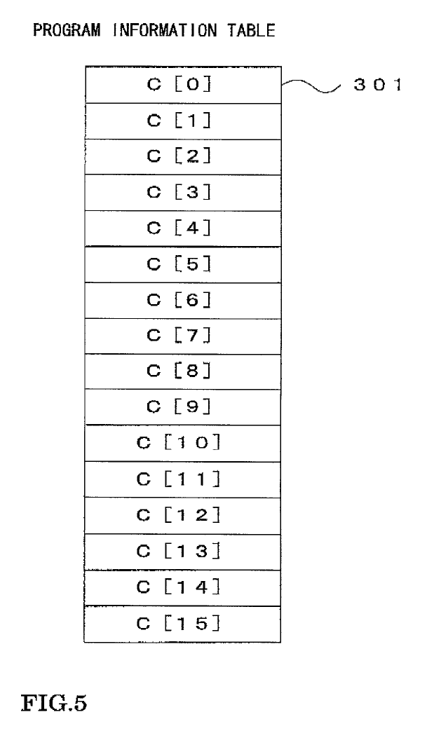

Upon reception of information regarding the selected program from the controller 11 through the input section 12, the program information storage section 16 sequentially stores a program information table 301 representing the received program. FIG. 5 is a diagram showing a format of the program information table 301 and the contents thereof stored in the program information storage section 16. As shown in FIG. 5, the program information table 301 is composed of sixteen storage areas corresponding to the respective sixteen type codes, a corresponding one of which is shown in the data area of “Program Type” 107 included in the EPG. Particularly, the program information table 301 is composed of sixteen storage areas in the form of directories C[0] to C[15]. The program information is stored in each of the directories. Every time the program information is received by the controller 11 via the input section 12, the controller 11 identifies a corresponding type code of the program which is included in the received program information. The controller 11 increments a value, by 1, of a counter in each directory of the storage area corresponding to the identified type code, and stores the value in the program information storage section 16.

The external storage section 17 stores, at a predetermined timing, the received program information which is stored in the program information storage section 16 and the value of the counter in each directory.

The controller 11 receives signals, which represents an EPG and the program corresponding to the channel selected by the tuner 2, from the demodulator 3 through the input section 12. The controller 11 identifies program information, such as program identification information or the like which is multiplexed and included in the received signals. Further, the controller 11 stores the program information in the program information storage section 16, and the received EPG in the EPG storage section 15.

Every time a program is received, the controller 11 refers to the EPG stored in the EPG storage section 15, in accordance with the program identification information of the received program. Then, the controller 11 identifies a type code corresponding to the received program, stores the identified program information in a storage area of the program information storage section 16, which corresponds to the identified type code, and updates the value of the counter which shows the number of times the corresponding type of program is watched or received by the user.

The controller 11 refers to the updated value of the counter of the program information storage section 16, and sends, to the ES selector 15, an ES selection control signal for selecting one elementary stream of a plurality of elementary streams included in the received signals. In response to the ES selection control signal, the controller 11 sends an elementary stream selected by the ES selector 15 to the output section 13.

Every time a program corresponding to a channel is selected by the user by manipulation of the tuner 2, the controller 11 updates the program information, according to types of program, stored in the program information storage section 16 and the value of each counter. The controller 11 stores the updated information in the external storage section 17 at a predetermined timing.

Furthermore, the controller 11 detects the presence of the digital signals received through the input section 12, and determines whether broadcast is being sent.

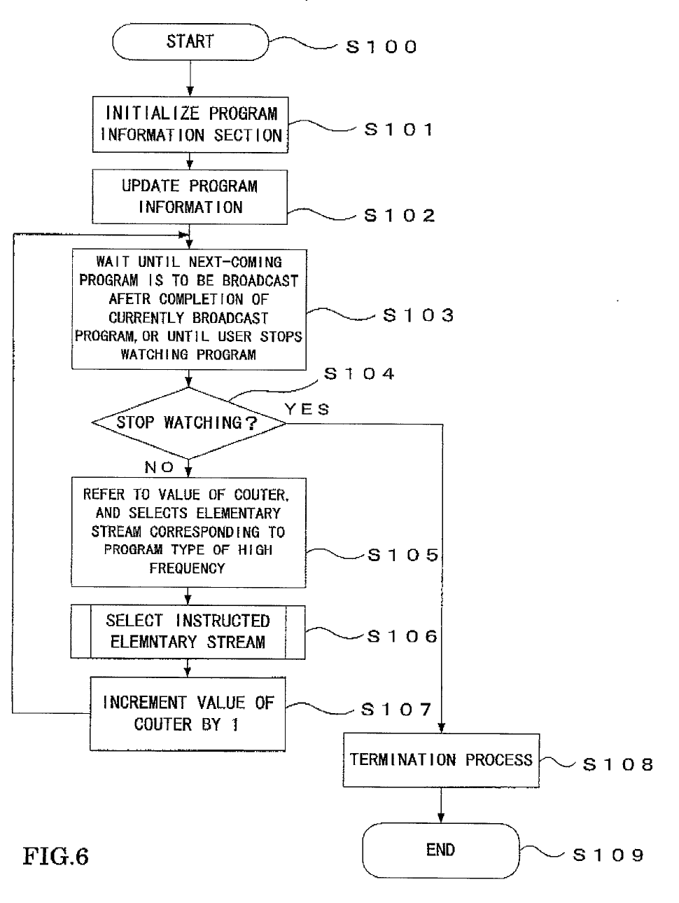

Operations of the program selection device 10 according to this embodiment will now be explained. FIG. 6 is a flowchart for explaining an ES selection process carried out by the program selection device 10.

The controller 11 initializes the EPG storage section 15 and the program information storage section 16. Then, the controller 11 clears the storage area, of the program information storage section 16, for storing the program information corresponding to the identified type code, and sets the value of the counter to “0” (Step S101).

Then, the controller 11 reads out the value of each counter and the program information of programs which have been watched by the user, from the external storage section 17, and updates the information stored in the program information storage section 16 based on the read program information (Step S102). The controller 11 waits until the next program is ready to be broadcasted after the completion of the currently-broadcasted program, or until the user stops watching the program (Step S103).

The controller 11 detects the presence of the digital signals through the input section 12, and determines whether the user stops watching the broadcasted program, i.e., whether the manipulation of the tuner 2 is made by the user in order to stop watching the program (Step S104). When determined that the user stops watching the program, the flow advances to a step S108, wherein a completion procedure for completing the ES selection process is performed.

In the step S108, the controller 11 stores the value of the counter and the program information, which are stored in the program information storage section 16 in association with the types of program, in the external storage device 17. Then, the controller 11 stops sending a control signal toward each section included in the program selection device 10, and suspends any operation performed by each section thereinside.

In the step S104, when determined that the program is completely broadcast or the next program is ready to be broadcast, the flow advances to a step S105. In the step S105, the controller 11 reads out an EPG regarding the program corresponding to the selected channel, from the EPG storage section 15, obtains the entire “ES Selection Information” in storage area(s) which are included in the read EPG, and extracts the data item of “ES Type” 203 included in each storage area of “ES Selection Information”.

Further, the controller 11 refers to the value of the counter included in each directory of the program information table 301 stored in the program information storage section 16, in association with the type code of the extracted ES type 203. Then, the controller 11 sends, to the ES selector 14, an ES selection control signal. The ES selection control signal is one for instructing to select an elementary stream corresponding to a type code of the largest counted value among any other counted values.

In response to the ES selection control signal, the ES selector 14 selects the instructed elementary stream of the plurality of elementary streams which are multiplexed with the currently-received program, and sends digital signals representing the program which includes the only selected elementary stream to the output section 13 (Step S106). The output section 13 sends the received digital signals to the decoder 4.

Thus sent digital signals are output on a monitor as image data, text data and voice data by the decoder 4 and the reproduction section 5 via the output section, so that the output data can be viewed by the user.

The controller 11 increments, by 1, the value of the counter included in a directory of the program information table 301 which corresponds to the type of the program described in the data area of “Type of Program” 107 (Step S107). Then, the flow returns to the step S103, wherein the controller 11 waits until the next program is ready to be broadcasted after the completion of the currently-broadcasted program, or until the user stops watching the program.

As explained, according to this embodiment, the program selection device 10 refers to the EPG so as to identify the type of program. In addition, of the plurality of elementary streams included in (multiplexed with) programs, the program selection device 10 outputs one elementary stream corresponding to a particular type of program which is most frequently watched by the user, based on the counted values representing the numbers of times the user has watched programs in association with the types of programs. Therefore, image data, text data and voice data corresponding to the interest and preference of the user can easily be sent to the user.

The present invention is not limited to the above-described embodiment, and modifications and changes may be thereonto.

For example, the program selection device 10, illustrated in FIG. 1, has been explained as one included in the receiver device 20. However, the program selection device 10 may be independent from the receiver device 20. Further, an ES filter mechanism for filtering predetermined ES signals may be included in the tuner 2 instead of the ES selector 14 in the program selection device 10, for example. In this structure, the controller 11 may control this ES filter mechanism so as to transmit, of a plurality of elementary streams, an elementary stream corresponding to a type of program which is viewed by the user at a high rate.

In the above-described embodiment, the external storage device 17 has been employed as a recording medium which records the past record of user viewing types of programs in accordance with his/her interest or preference. However, any other form of recording medium, such as a hard-disk, a CD-ROM, a memory card, etc., may be employed. Such recording medium may be employed as an internal storage device mounted into the program selection device 10 or the receiver device 20.

As explained in the above-described embodiment, in the step S108, the external storage device 17 stores the program information and the counted value of the counter which are originally stored in the program information storage section 16. The storing of the program information and the counted value may be performed at an arbitrary timing. For example, every time the user selects a channel corresponding to a particular program, the storing may be performed. Otherwise, the storing may be performed in response to an operation of the user.

In the above-described embodiment, the explanations have been made to the step S107, wherein the value of the counter corresponding to the selected program is incremented by 1.

However, before referring to the value of the counter in a corresponding directory of the program information table 301, the controller 11 may increment a value of a counter corresponding to a type code of the selected program by 1. After this, the controller 11 may refer to the value of the updated counter in the program information table 301, and instruct to select a particular elementary stream corresponding to a type of program with the largest counted value among any other counted values.

In the above-described embodiment, in the step S101 included in the process shown in FIG. 6, the counted values of the counters corresponding to types of program are set to “0”. However, the user may arbitrarily reset the value of the counters. Otherwise, the controller 11 may periodically reset the values of the counters at a predetermined timing.

The above-described embodiments is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-002367 filed on Jan. 11, 2000, and including specification, claims, drawings and summary. The disclosure of the above Japanese Patent Application is incorporated herein by reference in its entirety.

What is claimed is:

1. A program selection device which receives a plurality of programs and an EPG (Electronic Program Guide), and selects a particular elementary stream, of a plurality of elementary streams received together with one of the plurality of programs which is selected by a user, comprising:
a controller; and
a storage section, and
wherein said storage section stores a past record of the user viewing programs, in association with a plurality of predetermined types of the programs, and the received EPG, and
said controller identifies types of both the selected program and the multiplexed elementary streams in accordance with the EPG, calculates rates at which the user views programs in association with each of the types based on the past record, specifies a type of program based on the calculated rates, and selects an elementary stream corresponding to the specified type, of a plurality of elementary streams which are received together with the selected program.

2. A program selection device which receives a plurality of programs and an EPG, and selects a particular elementary stream, of a plurality of elementary streams received together with one of the plurality of programs which is selected by a user, said device comprising:
program receiving means for receiving the EPG, the selected program, and the plurality of elementary streams;
type identification means for identifying types of both the selected program and the plurality of elementary streams;
rate calculation means for calculating rates at which the user views programs in association with a plurality of program types;
rate storage means for storing the calculated rates in association with each of the program types; and
ES selection means for specifying a program type based on the calculated rates, and selecting an elementary stream of the plurality of elementary streams received by said program receiving means, the elementary stream corresponding to the specified program type.

3. The program selection device according to claim 2, wherein:
said rate storage means includes a counter for counting a number of times the user views programs in association with the program types; and
said rate calculation means increments, every time the user selects a program, a value of the counter corresponding each of the program types by 1, so as to obtain the rates based on the value of the counter.

4. The program selection device according to claim 1, wherein, of the plurality of elementary streams which are multiplexed and included in the program selected by the user, an elementary stream corresponding to a most-frequently watched program type is selected based on a calculation of said rate calculation means.

5. A program selection method for selecting a particular elementary stream of a plurality of elementary streams received together with one of the plurality of programs which is selected by a user, after receiving a plurality of programs and an EPG, said method comprising:
storing a past record of the user viewing programs in association with program types of the programs and the received EPG; and
identifying a program type of the selected program including the plurality of elementary streams based on the EPG, calculating rates at which the user views the programs in association with the program types based on the past record, and specifying a program type of a program based on the calculated rates, thereby to select one elementary stream of the plurality of elementary streams corresponding to the specified program type.

6. A program selection method for selecting a particular elementary stream of a plurality of elementary streams received together with one of the plurality of programs which is selected by a user, after receiving a plurality of programs and an EPG, said method comprising:
receiving a program selected by the user, the plurality of elementary streams and the EPG;
identifying a program type of the selected program including the plurality of elementary streams;
calculating rates at which the user views the programs in association with a plurality of program types;
storing the rates which are calculated in association with the plurality of program types; and
specifying a program type based on the calculated rates, thereby to select one elementary stream, corresponding to the specified program type, of the plurality of elementary streams received in said receiving.

7. The program selection method according to claim 6, wherein:
a counter for counting a number of times the user watches programs in association with the program types is used in said storing; and
in said calculating, every time the user selects a program, a value of the counter corresponding to each of the program types is incremented by 1, and the rates are obtained based on the value of the counter.

8. The program selection method according to claim 5, further comprising selecting, of the plurality of elementary streams which are multiplexed and included in the program selected by the user, an elementary stream corresponding to a most-frequently watched program type based on a calculation performed in said calculating.
